(19) United States
(12) Patent Application Publication
(10) Pub. No.: US 2006/0077416 A1
(43) Pub. Date: Apr. 13, 2006

(54) Image forming apparatus and method of controlling apparatus

(75) Inventor: Fumiyoshi Kittaka, Yokohama-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/945,776

(22) Filed: Sep. 20, 2004

(51) Int. Cl. G06K 15/00

(52) U.S. Cl. 358/1.14

(57) ABSTRACT

When an enabler key to enable a use of a specific function is set, use of a specific function corresponding to the set enabler key is permitted or prohibited in accordance with the department to which a user belongs.

### BACKGROUND OF THE INVENTION

1. Field of the Invention

The present invention relates to a multifunction image forming apparatus having a plurality of functions, and a method of controlling the apparatus.

2. Description of the Related Art

Multifunction image forming apparatuses (MFPs) have a plurality of functions such as a scanning function and a network printing function in addition to a general copy function.

In such a multifunction image forming apparatus, the copy function can be used as a standard function at any time. However, the scanning function and the network printing function can only be used by a user optionally selecting those.

However, depending on the department to which the user belongs, there are cases in which the department does not desire the user to use the scanning function or the network printing function from the standpoints of security and cost.

### BRIEF SUMMARY OF THE INVENTION

The present invention has been achieved in consideration of the above-described circumstances, and an object of the present invention is to provide an image forming apparatus which can manage permission or prohibition to use a specific function for each department to which a user belongs, and a method of controlling the apparatus.

The present invention is a multifunction image forming apparatus having a plurality of functions, comprising:

an enabler key to enable use of a specific function among the plurality of functions;

a set part to set the enabler key;

a registration part to register departments to which users of the apparatus are assigned, and to register permission or prohibition to use a specific function corresponding to the enabler key for the each assigned department;

an input part to input the assigned departments;

a determination part which, when the enabler key is set with respect to the set part and an assigned department is input at the input part, determines on the basis of the registered contents of the registration part whether use of the specific function corresponding to the enabler key set with respect to the set part is permitted or prohibited with respect to a user of the assigned department input at the input part; and

a control part which permits use of the specific function when the determined result at the determination part is permission, and which prohibits use of the specific function when the determined result at the determination part is prohibition.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is a perspective view showing an external view of an embodiment of the present invention;

FIG. 2 is a diagram showing a configuration of a control panel of the embodiment;

FIG. 3 is a block diagram of a control circuit of the embodiment;

FIG. 4 is a flowchart for explanation of the effect of the present invention;

FIG. 5 is a diagram showing a guide screen of management setting in the embodiment;

FIG. 6 is a diagram showing a setting screen for department names in the embodiment;

FIG. 7 is a diagram showing a setting screen for a management number in the embodiment;

FIG. 8 is a diagram showing a setting screen for permission/prohibition relating to a scan enabler key in the embodiment;

FIG. 9 is a diagram showing a setting screen for permission/prohibition relating to a network enabler key in the embodiment;

FIG. 10 is a diagram showing a setting screen for department names in the embodiment;

FIG. 11 is a diagram showing a setting screen for a management number in the embodiment;

FIG. 12 is a diagram showing a setting screen for permission/prohibition relating to the scan enabler key in the embodiment;

FIG. 13 is a diagram showing a setting screen for permission/prohibition relating to the network enabler key in the embodiment; and

FIG. 14 is a diagram showing an input screen of a management number in the embodiment.

### DETAILED DESCRIPTION OF THE INVENTION

Hereinafter, an embodiment of the present invention will be described with reference to the drawings.

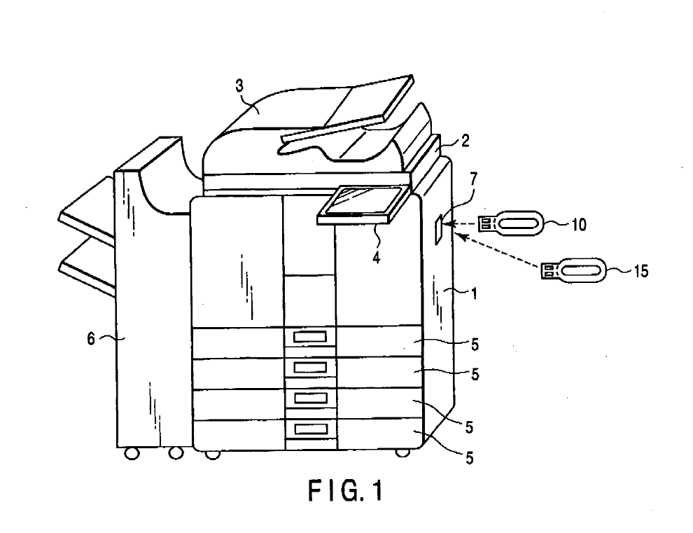

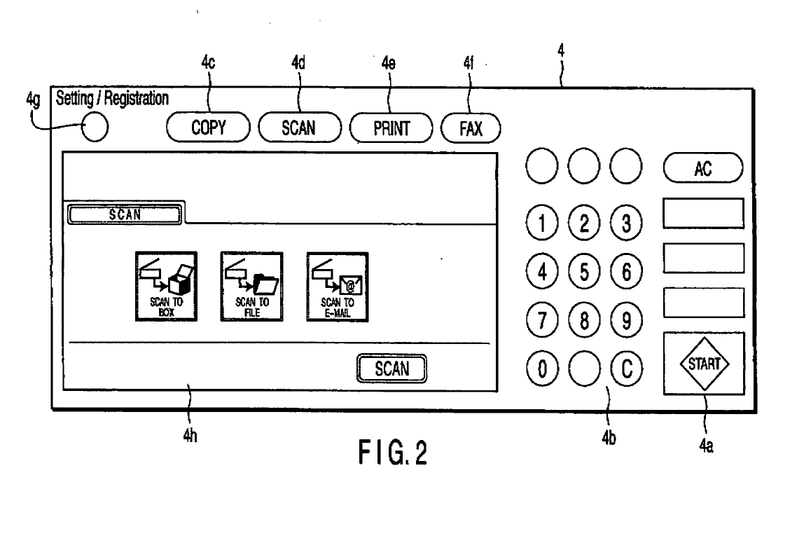

As shown in FIG. 1, a document table 2 is provided above a main body 1 of an image forming apparatus, and an automatic document feeder (ADF) 3 is provided on the document table 2 so as to be able to be freely opened and closed. At a position at the same height as the height of the document table 2, a control panel 4 shown in FIG. 2 is provided as operating means for setting operating conditions. The control panel 4 has a start key 4a, a numeric keypad 4b, a copy key 4c, a scan key 4d, a print key 4e, a facsimile key 4f, a setting/registration key 4g, a liquid-crystal display screen 4h, and the like, and functions as a management number input part which will be described later.

A plurality of cassettes 5 in which various sizes of paper sheets which are image forming media are contained are provided at the lower portion of the main body 1. A paper output unit 6 which receives output of printed paper sheets is provided at the side portion of the main body 1.

Further, a USS port 7 which is a set part with enabler keys is provided at the side portion of the main body 1. Setting of a scan enable key 10 and a network enabler key 15 which is selective with respect to the USB port 7 is possible.

The scan enabler key 10 is a key for enabling a use of the scanning function of the main body 1. As the scanning function, there are a scan-to-box function of storing image data scanned at the main body 1 into a hard disk device 25 which will be described later in the main body 1, a scan-to-file function of storing image data scanned at the main body 1 into personal computers 41 and 42 or the like which will be described later, a scan-to-e-mail function of transmitting image data scanned at the main body 1 to external devices in formats of e-mails, and the like.

The network enabler key 15 is a key for enabling use of the network printing function of printing image data transmitted from external devices to the main body 1, at the main body 1.

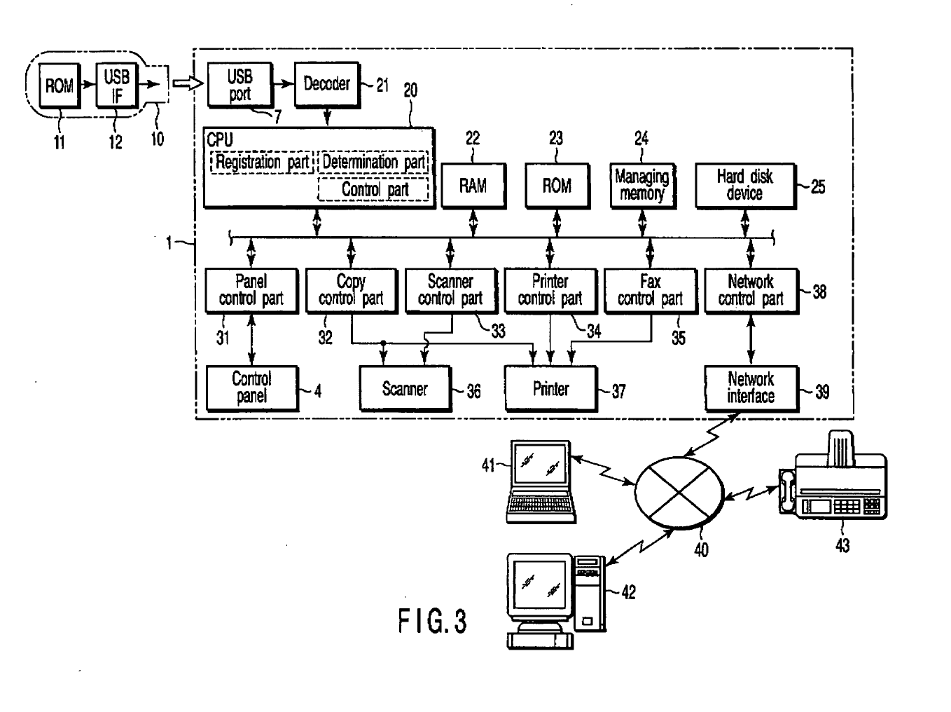

The internal configuration of an enabler key and the control circuit in the main body 1 are shown in FIG. 3.

A ROM 11 in which a code denoting the scanning function which is a specific function is stored, and a USB interface 12 for transmitting the code in the ROM 11 to the above-described USE port 7 are built into the scan enabler key 10. In the same way, the ROM 11 and the USB interface 12 are built into the network enabler key 15. A code denoting the network printing function which is a specific function is stored in the ROM 11 of the network enabler key 15.

A CPU 20 serving as a main control unit is provided in the main body 1. A decoder 21, a RAM 22, a ROM 23, a nonvolatile managing memory 24, the hard disk device 25, a panel control part 31, a copy control part 32, a scanner control part 33, a printer control part 34, a facsimile (fax) control-part 35, and a network control part 38 are connected to the CPU 20.

The above-described decoder 21 reads a code from the scan enabler key 10 or the network enabler key 15 which has been set with respect to the USB port 7. The code read at the decoder 21 is supplied to the CPU 20.

The RAM 22 is for storing various data. Various control programs needed for operating the main body 1 are stored in the ROM 23. Data of registration processing which will be described later is stored in the managing memory 24. Image data scanned at the main body 1 is stored in the hard disk device 25.

The panel control part 31 controls the control panel 4. The copy control part 32 controls a general copy function using a scanner 36 and a printer 37. The scanner control part 33 controls the scanning function (the scan-to-box function, the scan-to-file function, and the scan-to-e-mail function) using the scanner 36. The printer control part 34 controls the network printing function using the printer 37. The facsimile (fax) control part 35 controls the facsimile function using the scanner 36.

The network control part 38 controls data transmission/reception with respect to external devices via a network interface 39. The network interface 39 includes a LAN board, a fax modem, and the like, and is connected to the personal computers 41 and 42 and a facsimile device 43 or the like which are external devices, via external communication lines 40.

The CPU 20 has a registration part, a determination part, and a control part.

The registration part registers names of departments to which users are assigned and management numbers of the assigned departments with the managing memory 24, and executes processing in which permission and prohibition to use the specific functions respectively corresponding to the enabler keys 10 and 15 are registered with the managing memory 24 in accordance with the above-described each assigned department. The names of the departments to which the users are assigned and the management numbers of the assigned departments are input from the control panel 4.

The determination part executes processing in which, when the enabler key 10 or the enabler key 15 is set with respect to the USB port 7, and a management number is input from the control panel 4, it is determined on the basis of the registered contents of the registration part whether use of a specific function corresponding to the enabler key 10 or the enabler key 15 which has been set with respect to the USB port 7 is permitted or prohibited with respect to a user of an assigned department which corresponds to the management number input from the control panel 4.

The control part executes processing in which use of a specific function is permitted when the determined result at the above-described determination part is permission, and use of a specific function is prohibited when the determined result at the above-described determination part is prohibition.

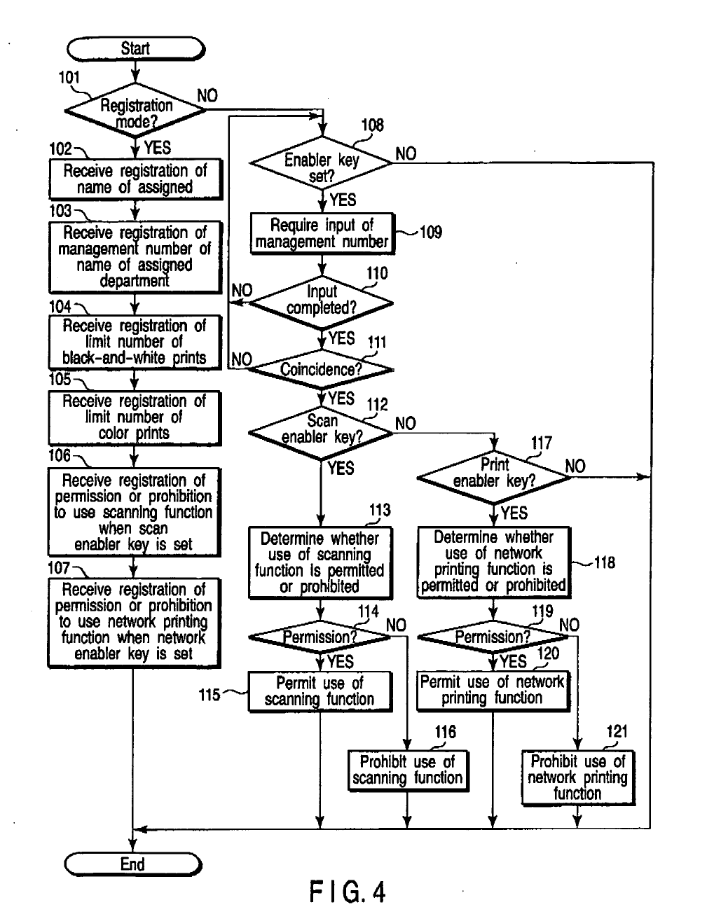

Next, the effect will be described with reference to the flowchart of FIG. 4.

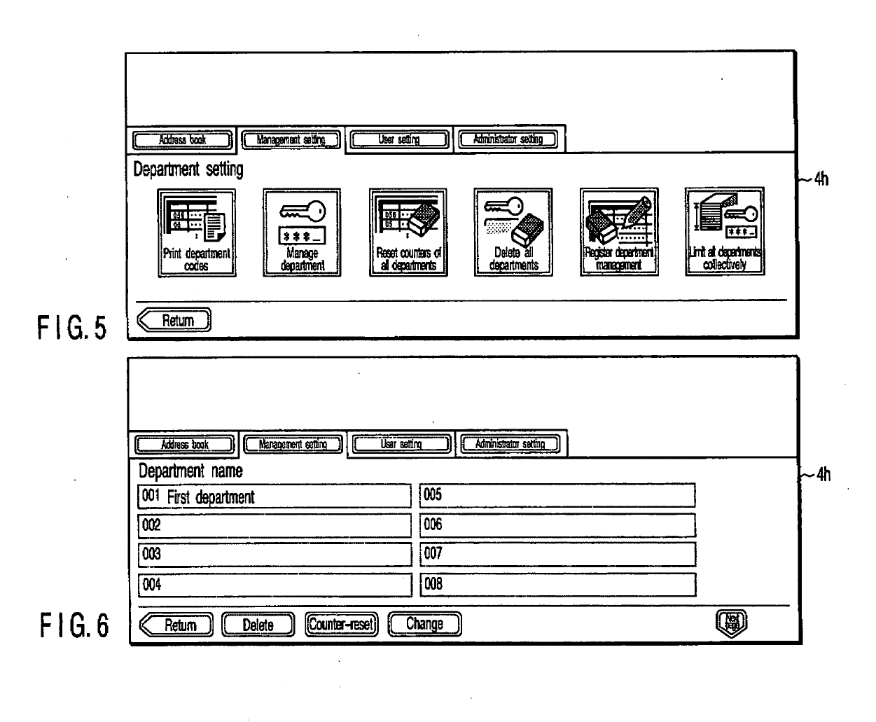

When the setting/registration key 4g on the control panel 4 is turned on by an administrator, a guide screen for management settings shown in FIG. 5 is displayed on the liquid-crystal display screen 5h of the control panel 4. When a department management registering button on the guide screen is touched to operate it, a department management registering mode is set (YES in step 101).

When the registering mode is set, a setting screen for department names as shown in FIG. 6 is displayed on the liquid-crystal display screen 5h. The administrator inputs an assigned department name, for example, “First department” to the setting screen, and touches a change button. Then, registration of the assigned department name “First department” is received (step 102).

When the registration of the assigned department name “First department” is completed, a setting screen for a management number as shown in FIG. 7 is displayed on the liquid-crystal display screen 5h. The administrator inputs a management number allocated to the “First department”, for example, “00001” to the setting screen, and touches a set button to operate it. Then, registration of the management number “00001” is received (step 103). Note that it is possible to input a limit number of black-and-white prints and a limit number of color prints to the setting screen for a management number. In accordance with the input, registrations of the limit number of black-and-white prints and the limit number of color prints are received (steps 104 and 105).

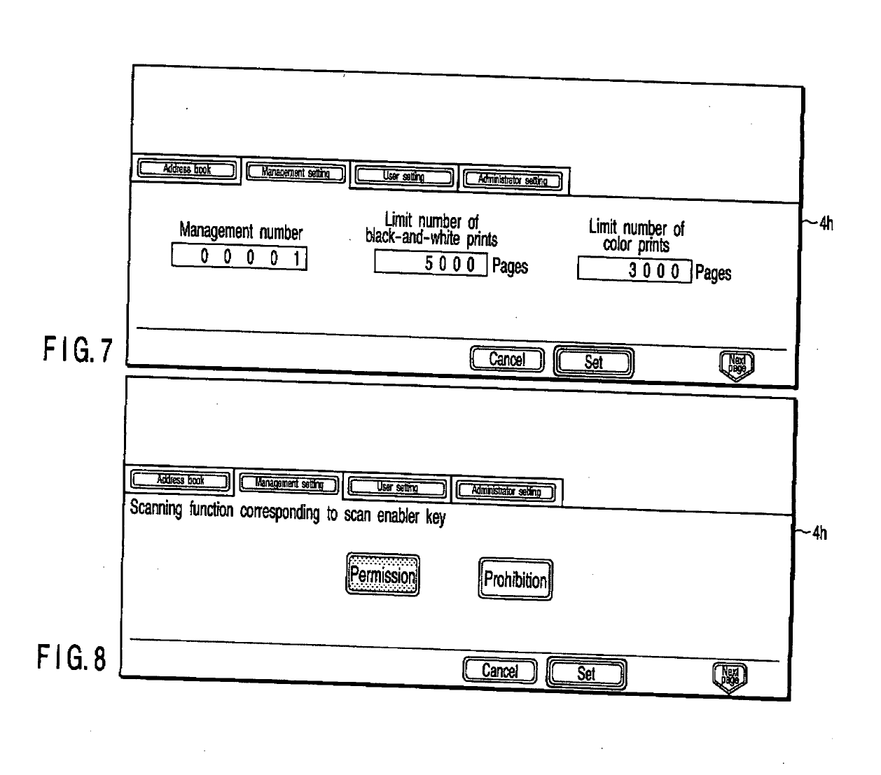

When the registrations of the management number, the limit number of black-and-white prints, and the limit number of color prints are completed, a setting screen for permission and prohibition relating to the scan enabler key 10 as shown in FIG. 8 is displayed on the liquid-crystal display screen 5h. The administrator touches one of the permission button and the prohibition button on the setting screen. Then, registration of permission or prohibition to use the scanning function when the scan enabler key 10 is set with respect to the USB port 7 is received (step 106). Namely, when the permission button is touched to operate it, “permission” is registered, and the permission button emits light of a specific color. The situation of the emission of light is shown by dots in FIG. B. In this case, use of the scanning function is permitted with respect to a user in the first department.

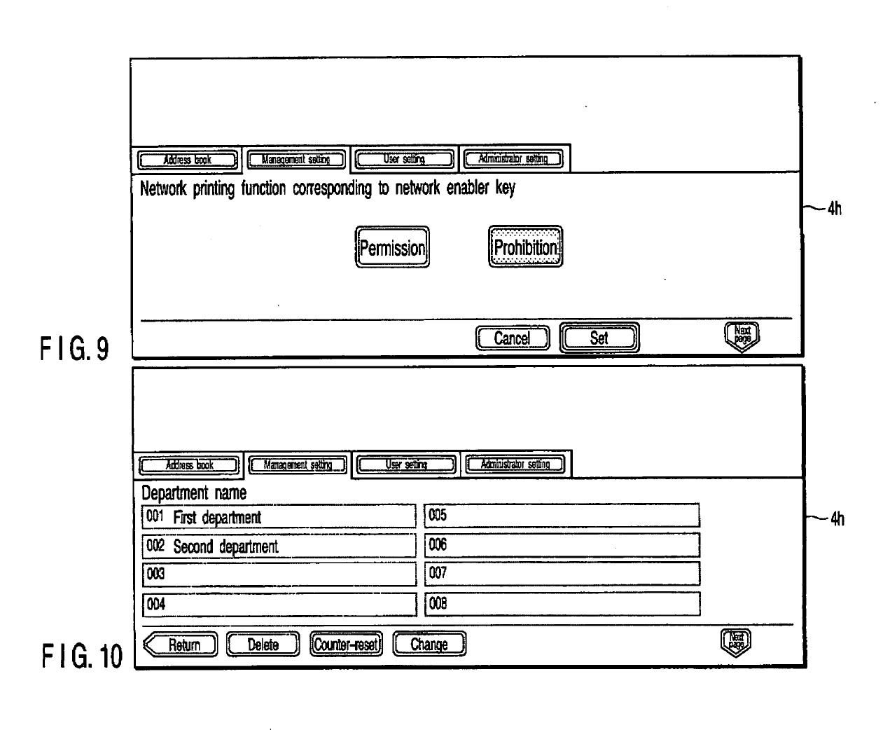

When the registration of permission/prohibition relating to the scan enabler key 10 is completed, a setting screen for permission and prohibition relating to the network enabler key 15 as shown in FIG. 9 is displayed on the liquid-crystal display screen 5h. The administrator touches one of the permission button and the prohibition button on the setting screen to operate it. Then, registration of permission or prohibition to use the network printing function when the network enabler key 15 is set with respect to the USB port 7 is received (step 107). Namely, when the prohibition button is touched to operate it, “prohibition” is registered, and the prohibition button emits light of a specific color. The situation of the emission of light is shown by dots in FIG. 9. In this case, use of the network printing function is prohibited with respect to a user in the first department.

When the registration of permission/prohibition relating to the network enabler key 15 is completed, a setting screen for department names as shown in FIG. 10 is displayed on the liquid-crystal display screen 5h again. The administrator inputs an assigned department name, for example, “Second department” to the setting screen, and touches the change button to operate it. Then, registration of the assigned department name “Second department” is received (step 102).

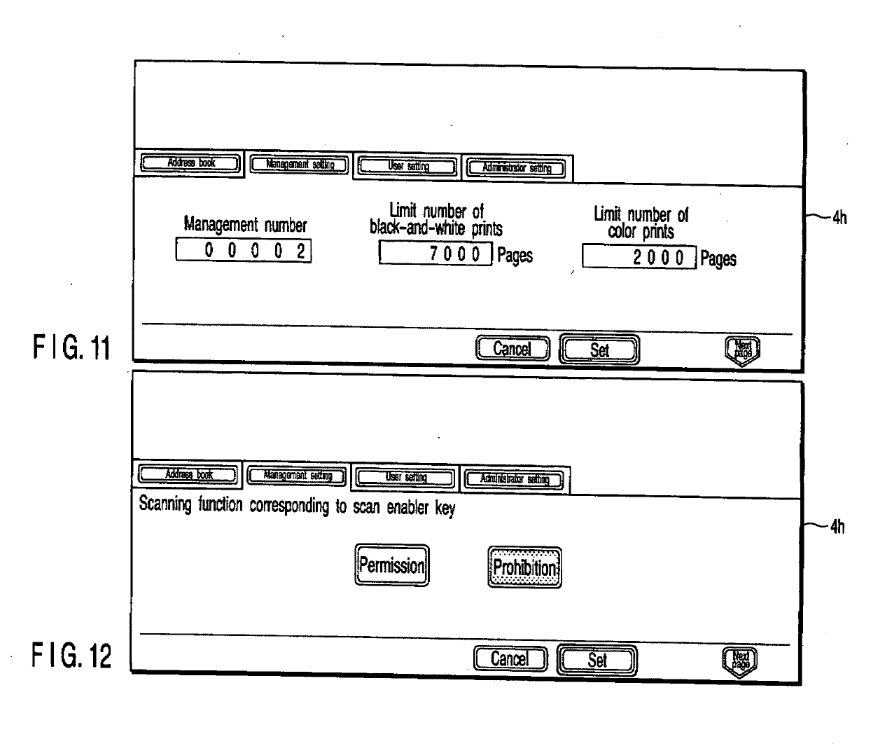

When the registration of the assigned department name “Second department” is completed, a setting screen for a management number as shown in FIG. 11 is displayed on the liquid-crystal display screen 5h. The administrator inputs a management number allocated to the “Second department”, for example, “00002” to the setting screen, and touches the set button to operate it. Then, registration of the management number “00002” is received (step 103). Note that it is possible to input a limit number of black-and-white prints and a limit number of color prints on the setting screen for a management number. In accordance with the input, registrations of the limit number of black-and-white prints and the limit number of color prints are received (steps 104 and 105).

When the registrations of the management number, the limit number of black-and-white prints, and the limit number of color prints are completed, a setting screen for permission and prohibition relating to the scan enabler key 10 as shown in FIG. 12 is displayed on the liquid-crystal display screen 5h. The administrator touches one of the permission button and the prohibition button on the setting screen to operate it. Then, registration of permission or prohibition to use the scanning function when the scan enabler key 10 is set with respect to the USB port 7 is received (step 106). Namely, when the prohibition button is touched to operate it, “prohibition” is registered, and the prohibition button emits light of a specific color. The situation of the emission of light is shown by dots in FIG. 12. In this case, use of the scanning function is prohibited with respect to a user in the second department.

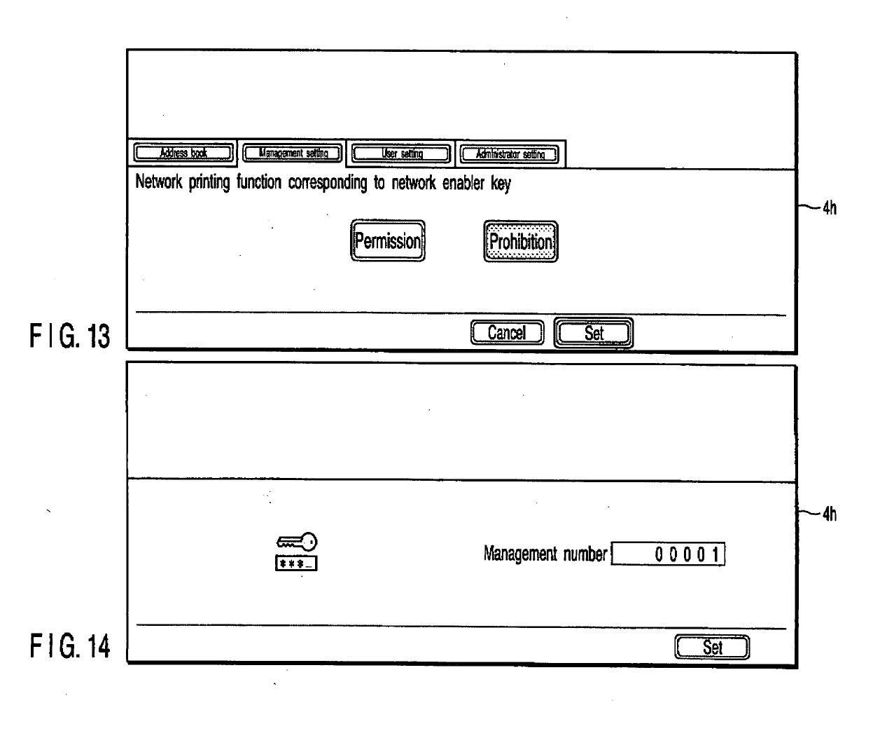

When the registration of permission/prohibition relating to the scan enabler key 10 is completed, a setting screen for permission and prohibition relating to the network enabler key 15 as shown in FIG. 13 is displayed on the liquid-crystal display screen 5h. The administrator touches one of the permission button and the prohibition button on the setting screen to operate it. Then, registration of permission or prohibition to use the network printing function when the network enabler key 15 is set with respect to the USB port 7 is received (step 107). Namely, when the prohibition button is touched to operate it, “prohibition” is registered, and the prohibition button emits light of a specific color. The situation of the emission of light is shown by dots in FIG. 13. In this case, use of the network printing function is prohibited with respect to a user in the first department.

Registrations are completed as described above.

When one of the scan enabler key 10 and the network enabler key 15 is set with respect to the USB port 7 of the main body 1 (YES in step 108), a screen on which input of a management number is required as shown in FIG. 14 is displayed on the liquid-crystal display 5h (step 109). In the case of a user belonging to the first department, as shown in FIG. 14, a management number “00001” is input and the set button is touched to operate it. In accordance therewith, the input of the management number “00001” is completed (YES in step 110).

If the input management number “00001” is coincident with a management number registered in advance (YES in step 111), the type of enabler key which has been set with respect to the USB port 7 is determined (step 112).

When the scan enabler key 10 has been set (YES in step 112), it is determined whether use of the scanning function is permitted or prohibited with respect to a user in the first department corresponding to the management number “00001” (step 113). Because permission has been registered in the above-described registering mode, the determined result is made to be “permission” (YES in step 114). In this case, use of the scanning function is permitted with respect to a user in the first department (step 115). When use of the scanning function is permitted, as shown in FIG. 2, selective buttons for the various scanning functions are displayed on the liquid-crystal display screen 4h of the control panel 4.

If prohibition has been registered in the above-described registering mode, the determined result is made to be “prohibition” (NO in step 114). In this case, use of the scanning function is prohibited with respect to a user in the first department (step 116).

When the network enabler key 15 has been set (NO in step 112), it is determined whether use of the network printing function is permitted or prohibited with respect to a user in the first department corresponding to the management number “00001” (step 118). Because prohibition has been registered in the above-described registering mode, the determined result is made to be “prohibition” (NO in step 119). In this case, use of the network printing function is prohibited with respect to a user in the first department (step 121).

If permission has been registered in the above-described registering mode, the determined result is made to be “permission” (YES in step 119). In this case, use of the network printing function is permitted with respect to a user in the first department (step 120).

As described above, use of the scanning function by setting the scan enabler key 10 and use of the network printing function by setting the network enabler key 15 can be permitted or prohibited in accordance with the department to which a user belongs. Accordingly, use of the scanning function and use of the network printing function can be appropriately managed from the standpoints of security and cost.

In the present embodiment, an example in which specific functions are the scanning function and the network printing function has been described. However, a case in which specific functions are other functions can be implemented in the same way.

Additional advantages and modifications will readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A multifunction image forming apparatus having a plurality of functions, comprising:
an enabler key to enable use of a specific function among said plurality of functions:
a set part to set the enabler key;
a registration part to register departments to which users of the apparatus are assigned, and to register permission or prohibition to use a specific function corresponding to the enabler key for said each assigned department;
an input part to input the assigned departments;
a determination part which, when the enabler key is set with respect to the set part and an assigned department is input at the input part, determines on the basis of the registered contents of the registration part whether use of the specific function corresponding to the enabler key set with respect to the set part is permitted or prohibited with respect to a user of the assigned department input at the input part; and
a control part which permits use of the specific function when the determined result at the determination part is permission, and which prohibits use of the specific function when the determined result at the determination part is prohibition.

2. An apparatus according to claim 1, wherein
the specific function is a scanning function and a network printing function.

3. An apparatus according to claim 2, wherein
the enabler key is a scan enabler key to enable use of the scanning function, and a print enabler key to enable use of the network printing function.

4. An apparatus according to claim 1, wherein
the enabler key has a memory, the memory having a code denoting the specific function stored therein.

5. A multifunction image forming apparatus having a plurality of functions, comprising:
an enabler key to enable use of a specific function among said plurality of functions;
a set part to set the enabler key;
a registration part to register names of departments to which users of the apparatus are assigned and management numbers of the assigned departments, and to register permission or prohibition to use a specific function corresponding to the enabler key for said each assigned department;
an input part to input the management numbers;
a determination part which, when the enabler key is set with respect to the set part and a management number is input at the input part, determines on the basis of the registered contents of the registration part whether use of the specific function corresponding to the enabler key set with respect to the set part is permitted or prohibited with respect to a user of the assigned department corresponding to the management number input at the input part; and
a control part which permits use of the specific function when the determined result at the determination part is permission, and which prohibits use of the specific function when the determined result at the determination part is prohibition.

6. An apparatus according to claim 5, wherein
the specific function is a scanning function and a network printing function.

7. An apparatus according to claim 6, wherein
the enabler key is a scan enabler key to enable use of the scanning function, and a print enabler key to enable use of the network printing function.

8. An apparatus according to claim 5, wherein
the enabler key has a memory, the memory having a code denoting the specific function stored therein.

9. A method of controlling a multifunction image forming apparatus having a plurality of functions, the method comprising:
when an enabler key to enable a specific function among said plurality of functions is set, determining on the basis of conditions registered in advance whether use of a specific function corresponding to the set enabler key is permitted or prohibited with respect to a user of departments to which users of the apparatus are assigned;
permitting use of the specific function when the determined result is permission; and
prohibiting use of the specific function when the determined result is prohibition.

10. The method according to claim 9, wherein
the specific function is a scanning function and a network printing function.

11. The method according to claim 10, wherein
the enabler key is a scan enabler key to enable use of the scanning function, and a print enabler key to enable use of the network printing function.

12. The apparatus according to claim 9, wherein
the enabler key has a memory, the memory having a code denoting the specific function stored therein.
